(19) United States
(12) Patent Application Publication
(10) Pub. No.: US 2003/0122666 A1
(43) Pub. Date: Jul. 3, 2003

(54) Method and apparatus for precise location of objects and subjects, and application to improving airport and aircraft safety

(76) Inventors: Eugene Britto John, Austin, TX (US); Heinrich Daniel Foltz, Edinburg, TX (US)

Correspondence Address: EUGENE JOHN, 7112 RIDGE OAK RD., AUSTIN, TX, 78749, US

(21) Appl. No.: 10/037,862

(22) Filed: Jan. 3, 2002

(51) Int. Cl. G08B 1/08

(52) U.S. Cl. 340/539.13; 340/825.49; 342/42

(57) ABSTRACT

This application describes a method and apparatus for precisely pinpointing and locating moving or stationary objects, with application to the real time monitoring of the precise position of airplanes and other vehicles on runways and other portions of airports. The invention is also capable of locating and monitoring equipment for servicing aircraft and the efficient allocation and coordination of the equipment. Additional capabilities of the invention include remote disabling of location sensing for particular objects, automatic generation of alarm conditions when objects are in danger of collision, and automatic broadcast of alarm conditions to occupants of located vehicles or aircraft Additional applications include location and pinpointing of balls, game equipment, players, and officials in sports; prisoners in prisons; children in childcare facilities; pets in and around homes, apartments or any living areas; animals in farms or zoological gardens (zoo); and more generally subjects in any area with predetermined boundaries. The method employs a continuous wave or pulse transmitter in the object to be located, and requires no high-speed or precision timing circuitry. By incorporating a receiver also in the object, control of the object is also possible.

### CROSS REFERENCE RELATED APPLICATIONS

Patent Application entitled Method and Apparatus for Location of Objects, and Application to Real Time Display of the Position of Players, Equipment and Officials During a Sporting Event, filed on Dec. 27, 2001

(Inventors: Eugene Britto John, U.S. Citizen, of Austin, Tex. and Heinrich Daniel Foltz, U.S. Citizen, of Edinburg, Tex.

### STATEMENT REGARDING FEDERALLY SPONSORED RESEARCH

Not Applicable

### REFERENCE TO SEQUENCE LISTING

Not Applicable

### FIELD OF INVENTION

The present invention is directed to a system for precisely locating and identifying single or multiple moving or stationary objects. The objects could be non-living things or living subjects. The system is applicable for improving safety of airports, and for tracking objects and/or subjects in childcare, prisons, zoos, farms, sporting arenas, etc.

### BACKGROUND OF THE INVENTION

The present invention is directed to a system for precisely locating, pin-pointing and identifying single or multiple moving or stationary objects. The system is applicable for improving safety of airports, and for tracking objects and/or subjects in childcare, prisons, zoos, farms, sporting arenas, etc.

An important aspect of airport safety is preventing collisions between aircraft on the ground, between aircraft and service vehicles, and between aircraft taking off and landing and aircraft or vehicles on the ground. Aircraft may enter into wrong runways and collide into objects or other aircraft resulting in major crashes. Such accidents can be prevented if the airport control can sense the entry of the aircraft into the wrong runway. Precise location and identification of aircraft and vehicles is critical in preventing such collisions. The present invention presents a method and apparatus for this purpose. Currently, ground radar is commonly used to locate objects on or near the runways and other safety critical areas of airports. While radar has the advantage of detecting any reflecting object, radar does not allow identification of individual aircraft and vehicles, and the reflecting properties of objects cannot be easily switched on or off if necessary.

Similarly, being able to monitor location of children in day care, school, malls, playground, etc can improve safety of children. Ability to pinpoint and identify location of each prisoner in real time in prison, work sites, etc can avoid prison escapes. Those involved in a prison fight or conspiracy can be easily identified. Similarly, location of pets in homes, animals in zoos/farms, etc can add to the safety and efficient management of animals. GPS (Global positioning system) can be used for these applications, however the accuracy of CPS is in meters and is inadequate for many of these applications, and GPS receivers are in general bulky.

The objects or subjects to be tracked are contemplated as being fitted with a simple transmitting device. No receiver is generally required to be present on the object. In some situations, it might be beneficial to have a receiver attached to the object, to be able to selectively turn on/off certain objects that have been located, to change their operating frequency, etc.

The present invention can also be used to the precise location of equipment and paraphernalia utilized in playing, scoring and officiating sporting events, as well as tracking the players, coaches and officials and the officials' equipment during the sporting event. The sporting event may be any sporting event, including but not limited to, football, baseball, golf, tennis, field hockey, ice hockey, soccer, basketball, or for that matter any of the events contested at the Olympics. In football, the tracking of the officials' flags, markers, etc. will enhance the officiating by determining the exact location of the game ball, with respect to the out of bound lines, first down markers, goal line, field goal uprights, etc.

As mentioned before, the accuracy of GPS is inadequate for applications envisaged above. Other techniques for the above applications attach a transmitter to the object to be tracked, and then use direction finding receivers to locate the object. There are several variations on this technique. Some include triangulation using two or more direction finding (nulling type) antennas, either mechanically or electronically steered. Such systems require either mechanical motion of the direction finding antennas, which decreases reliability, or electronic phasing which requires complex circuitry. Other systems operate by using a pulsed transmitter, and then measuring the time delay for the signal to arrive at three or more receiving locations. These systems require very precision timing circuitry to locate objects with the accuracy that would be needed to make a system useful in the envisaged applications.

The apparatus described here does not require any form of receiver on or in the object to be tracked; do not utilize any steered antennas; and does not need precision timing circuitry. Three dimensional location can be obtained using only a simple transmitter on the object to be tracked along with two (or more) pairs of antennas with receivers distributed around the perimeter of the area within which the object is to be tracked. The system measures the phase shift in the arrived signal within each closely spaced pair of antennas to obtain three (or more) direction vectors that give a coarse position of the object. The fine position of the object is then resolved by measuring the phase shift in the arrived signal between widely spaced pairs of elements. At very high frequencies (VHF) a phase measurement accuracy of 1-2 degrees is sufficient to give the required accuracy in the determination of the objects location.

### SUMMARY OF THE INVENTION

As explained before, the present invention is directed to a system for precisely locating, pin-pointing and identifying single or multiple moving or stationary objects. The system is applicable for improving safety of airports, and for tracking objects and/or subjects in childcare, prisons, zoos, farms, sporting arenas, etc.

The objects or subjects to be tracked have transmitters/sensors that emit radio, magnetic or similar waves, and are located by triangulation. The present invention is capable of tracking multiple sensors and providing data regarding their exact position in the x, y and z directions and their relative position and speed to other objects/subjects fitted with the sensors.

The present invention is capable of eliminating or selectively tracking sensors, so that even though all the players at a time are fitted with a sensor, all of them need not be tracked at any one time. Although, the present invention is capable of tracking an unlimited number of sensors it will often be practical to only track a few at a time to reduce the amount of data and clutter.

The sensors of the preferred embodiment of the present invention utilize a high frequency in the megahertz range to enable better resolution, although lower frequencies can also be employed. A circuit in the sensor uses phase detection which increases resolution at a lower cost than conventional methods.

The present invention utilizes two or more sets of widely spaced antennas, each of which consist of a pair of closely spaced antennas. A transmitter, which may emit either a continuous wave or modulated signal, is attached or embedded within the object to be tracked. Systems emitting pulse trains can also be envisioned. A system of receiving antennas is dispersed around the area in which the object is to be tracked. The antennas are arranged in pairs, and two or more such pairs will be used. In the preferred embodiment, the antennas within each pair are relatively closely spaced (typically one-quarter wavelength, more or less), and three or more such pairs are dispersed around the perimeter of the area of interest; however, other antenna arrangements may also be practicable. Each antenna is connected to a receiver, which amplifies and filters, and in the preferred embodiment downconverts the signal, maintaining phase coherence by deriving the local oscillators for all the receivers from a single or multiple source. The relative phase difference in signals from antennas within each pair are used to determine the rough or coarse location of the object. The relative phase difference in signals from widely separated antennas is then used to resolve fine and coarse location.

In one application, the object to be located would typically be aircraft and service vehicles in an airport. It could be children in a daycare, prisoners in a prison or off-prison worksite, animals in a farm/zoo/national preserve, a ball or other game paraphernalia, or a player, in a sporting event, or basically objects/subjects in any defined area. The system can obviously be used in many of the conventional applications of radiolocation and GPS.

### BRIEF DESCRIPTION OF THE DRAWINGS

FIG. 1 is a general view of an embodiment of the present invention, illustrating the antennae, receiver, and data processing units.

FIG. 2 is a detailed block diagram of the receiver, which is a sub module of the preferred embodiment of FIG. 1 of the present invention.

FIG. 3 illustrates the method of operation of the invention.

FIG. 4 illustrates a method of incorporating a receiver into object transmitter.

FIG. 5 illustrates interactive display that can be incorporated into the system.

### DETAILED DESCRIPTION

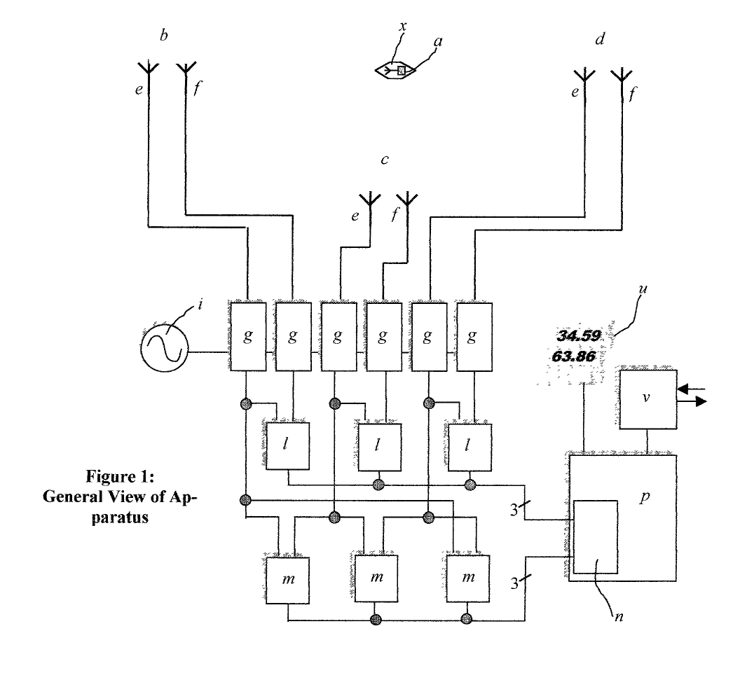

Referring to FIGS. 1, 2, and 3, the object to be located (x) has attached to it or embedded within it a small, low-powered radio transmitter and antenna (a) emitting radiation. Two or more pairs of antenna elements (in the figure we have shown three, namely, b, c, and d) are dispersed around the perimeter of the area in which the object is to be located, and receive signals from the transmitter. Within each pair of elements, the two elements, designated as primary (e) and secondary (f) are spaced approximately ¼ wavelength apart. The total number of antenna elements is at least four; for improved accuracy six or more elements are used in the preferred embodiment.

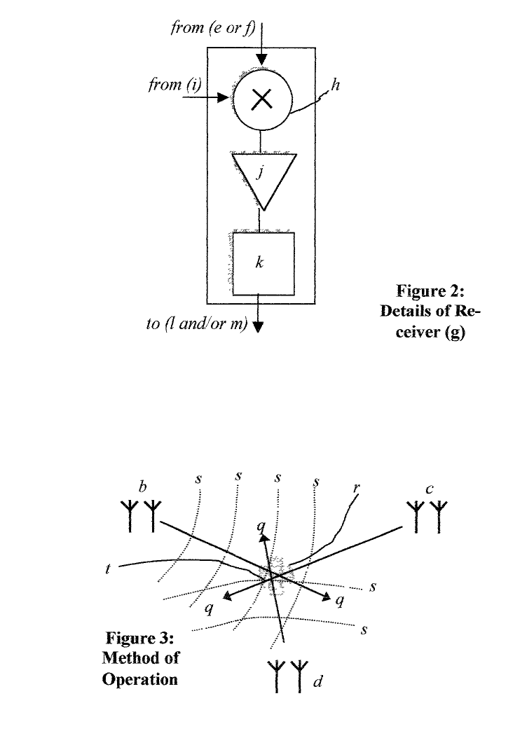

Each of the antenna elements is attached through a cable to a receiver assembly (g). Each receiver assembly, detailed in FIG. 2, contains a downconvertor (h) and intermediate frequency amplifier (j) which lower the received signal to a frequency suitable for low-cost phase locking and phase detection. It is possible to omit the downconversion and perform phase locking and detection directly at the transmitter frequency; however, the preferred embodiment employs downconversion to gain the advantages of a superhetrodyne receiver, familiar to skilled practioners of radio design. The local oscillator signal or signals for each of the downconvertors is derived from a signal source (i) in order to maintain phase coherence. In the case of multiple conversion downconvertors, each of the local oscillator frequencies required is derived from a signal source.

The output of the intermediate frequency amplifier (j) is the input to a phase locked loop (k) for each of the receivers, in order to stabilize the amplitude of the signal and reduce the effects of noise.

The outputs of the phase locked loops are connected to phase detectors (l) which find the phase difference between two signals. They are connected in the following sequence: the two signals (primary and secondary) originating with element pair (b) are connected to one phase detector, the two signals (primary and secondary) originating with element pair (c) are connected to a second phase detector, the two signals (primary and secondary) originating with element pair (d) are connected to a third phase detector. If additional element pairs are present they are connected in a continuation of the above sequence.

The outputs of the primary elements in each of the element pairs are simultaneously connected to another series of phase detectors (m). They are connected in the following sequence: the signal originating from the primary element of element pair (b) is connected along with the signal originating from the primary element of element pair (c) to one phase detector. The signal originating from the primary element of element pair (c) is connected along with the signal originating from the primary element of element pair (d) to a second phase detector. The signal originating from the primary element of element pair (d) is connected along with the signal originating from the primary element of element pair (b) to a third phase detector. If additional element pairs are present they are connected such that all combinations of two signals originating from primary elements are each fed to a phase detector (m).

The outputs from the first set of phase detectors (l) may be in the form of an analog level proportional to phase or a pulse train with duty cycle proportional to phase, depending on the type of phase detector selected. In either case, the outputs are connected to a data acquisition unit (n) and computer (p), and are used to compute a direction of arrival of the radio wave from the transmitter, at each of the element pair locations. The resulting direction vectors (q) (FIG. 3) can be intersected (r) to approximately locate the object of interest (x). An accuracy of one degree will correspond to an accuracy of approximately one degree in the direction vector, and the intersection of a number of such direction vectors will yield an accuracy of approximately two meters in an area 100 meters square, yielding the coarse location of the object.

The outputs from the second set of phase detectors (m) may likewise be in the form of an analog level proportional to phase or a pulse train with duty cycle proportional to phase. The outputs are connected to the same data acquisition unit (n) and computer (p). The phase differences of each pair define a set of loci of points (s) along which the object of interest (x) must lie. The loci are separated by a distance of one wavelength; therefore, if the wavelength is as long as the accuracy of the direction vector intersection (r), there will be no ambiguity about the particular locus containing the object of interest. The particular locus computed from the output of each of the phase detectors (m) may be intersected with the loci of the other phase detectors in set (m) to yield a location estimate (t) with greatly increased accuracy over the direction vector intersection. An accuracy of one degree will yield an accuracy of one three-hundred-sixtieth (1/360^{th}) of one wavelength in physical position. In the preferred embodiment, the object can be located with less than one inch resolution. Therefore, the first set of phase detectors (l) produce coarse location, and the second set (m) are then used to refine the accuracy within the zone defined by the first set (l). Small variations in phase due to local topography or obstructions such as trees or buildings can be compensated by surveying the site after the system is installed and creating a calibration table.

The above method and apparatus can be used alone as one embodiment of the invention. The data can be stored in the computer (p) to provide a permanent record of the object's motion and/or displayed on the computer screen with appropriate software.

In another embodiment, for usage in airport safety, extra apparatus is added consisting of a large digital display (u) and/or a video overlay interface (v), on which the position information is displayed for the convenience of control tower officials and other personnel responsible for the security of the airport and aircraft.

In another embodiment, for usage at spectator sporting events, extra apparatus is added consisting of a large digital display (u) and/or a video overlay interface (v), on which the position information is displayed for the convenience and entertainment of officials, players, and spectators.

The invention and the location information it provides can clearly be applied in a wide range of other applications in which accurate positioning is required, and many alternative designs for each of the component elements of the system will be apparent to skilled practitioners familiar with radio electronics.

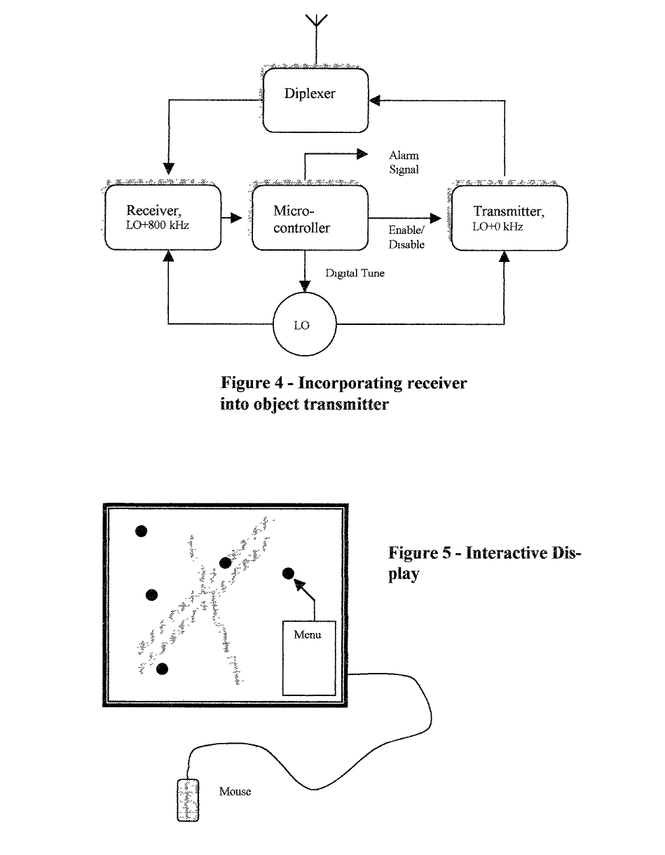

The object may contain a receiver in addition to the transmitter in the above description of the embodiment. A diagram of how the receiver may be configured is shown in FIG. 4. If a receiver is also included, it will be possible to control the object transmitter (eg: switch the transmitter on or off, or change the transmitter frequency) and/or communicate with the object transmitter. This has several advantages, including (1) the ability to temporarily remotely turn off object transmitters for objects that are known to be in safe locations, (2) the ability to dynamically assign frequencies to objects to avoid frequency conflicts, for example, aircraft approaching an airport or departing from a gate, and (3) the ability to automatically detect and distribute alarm conditions.

In dynamically assigning of frequencies, a system may be adopted by which each object receives at a frequency offset by a fixed amount from its transmit frequency. For example, the objects in an area may have transmit frequencies of 49.00, 49.05, 49.10, 49.15 MHz, and receive frequencies of 49.80, 49.85, 49.90, 49.95 MHz, respectively. These frequencies are merely representative of the frequency ranges contemplated by the invention for a particular application, but the invention is not limited to operating at these frequencies. The full spectrum of frequencies are available for use by the invention.

A particular frequency pair, for example 49.00 and 49.80 MHz, can be reserved for new objects entering the area covered by the system. When the location system detects the new object, it can immediately reassign it to a new, currently unused frequency pair.

In another embodiment for automatic detection and broadcast of alarm conditions, the computer (p) can detect the proximity versus time of two objects. If the objects fall within a predetermined distance of each other, or the rate at which they are approaching is deemed dangerous, an alarm signal can automatically be generated and transmitted to the objects on their pre-assigned receive frequencies.

In another embodiment, as shown in FIG. 5, an interactive map-like display of object positions in real time can be created, allowing the user to point and click on objects to disable their transmitters, reassign frequencies, or manually generate the transmission of an alarm signal.

In an alternate embodiment, the present invention is capable of being employed to more efficiently utilize equipment and resources at an airport or similar type business. Any business which employs equipment to service a particular craft are applicable to the present invention. By knowing the precise location of all of the equipment and whether or not it is moving, and in what direction it is moving, dispatchers can more efficiently coordinate equipment and workers to service the craft. For example, once an airplane lands, the dispatcher can determine where the closest unengaged baggage loading carts are and direct them to that airplane's gate. This process can also be employed for refueling and catering etc. By knowing where the equipment is, an efficient allocation of service equipment can be maintained. The dispatcher, via radio, PDA, laptop, pager, cell-phone or other communication devices can coordinate the efficient application of the equipment needed to service an aircraft, sea vessel, truck, etc.

In an alternate embodiment the number of antenna is increased along with the corresponding equipment to increase the resolution and to provide a more accurate location of the objects/subjects. As the number of antenna increases the accuracy can be reduced to mere millimeters.

In a still further embodiment of the present invention a laser tracking system can be utilized, wherein the sensor is coated with a material that can be tracked by a laser, thus further eliminating the potential of radio wave interference of the equipment. In a yet further embodiment of the present invention a magnetic field can be generated by the sensor, such as a magnet (passive device), which can be sensed and located, thus increasing the life expectancy of the sensor due to battery life limitations.

The present invention can be used in many applications where subjects or objects move within a defined territory. The advantages of the invention include low cost and high accuracy or precise resolution. The foregoing detailed description of the invention has been presented for purposes of illustration and description only. It is not intended to be exhaustive or to limit the invention to the precise form disclosed. Obviously many modifications and variations are possible in light of the above teaching.

What is claimed is:

1) A system for pinpointing the precise three-dimensional location and identification of single or multiple, moving or stationary objects in a predefined area, comprising: a transmitter and antenna within or attached to each object, and two or more pairs of receiving antennas dispersed around the perimeter of the predefined area.

2) The implementation of a system as claimed in (1), through the use of the following elements:
(a) Four or more antennas, arranged in two or more closely spaced pairs dispersed in or around the area to be covered,
(b) Downconvertors or receivers attached to each of the antennas, with the local oscillators of the downconvertors in all the receivers derived from a single reference;
(c) Phase locked loops to stabilize and reject noise in the downconverted signals;
(d) Phase detectors to determine the phase difference between the received signal in each pair of antennas;
(e) Phase detectors to determine the phase difference between the received signal in antennas not in the same pair.

3) In the system according to claim 1, wherein phase comparison between the down-converted signals from each pair of receiving antennas, to establish a rough location, phase comparison between the down-converted signals elements selected from different pairs, to precisely resolve the location.

4) In the system according to claim 1, wherein a variable frequency local oscillator is utilized to enable selective reception of signals emanating from individual objects.

5) In the system according to claim 1, wherein additional receivers in each object are capable of being enabled and disabled by an object transmitter, and further wherein object transmitter frequency is assignable and an alarm signal is capable of being transmitted to the object being tracked.

6) In the system according to claim 1, further comprising computing algorithms or circuitry to automatically detect hazardous proximity of objects or hazardous rate of approach of objects and to automatically transmit alarm signals.

7) The system according to claim 1, further comprising surveillance and tracking devices for precise location and identification of single or multiple moving or stationary aircraft and service vehicles.

8) The system according to claim 1, capable of pinpointing and identifying each child in real time at one of a day care, school, mall and play ground area.

9) The system according to claim 1, capable of pinpointing and identifying each prisoner in real time at one of a prison, work detail off site, jail and penitentiary.

10) The application of the system according to claim 1, capable of pinpointing and identifying pets in real time in at least on of homes, apartments or any living quarters.

11) The application of the system according to claim 1, capable pinpointing and identifying livestock or animals in a zoo or preserve or national park.

12) The application of the system according to claim 1, for aiding and training in officiating of any sporting events.

13) The application of the system according to claim 1 for generation of statistics in sporting events.

14) The application of the system according to claim 1, capable of pinpointing and accurately determining yardage of first downs in a football game.

15) The application of the system according to claim 1 for enhancing playing of sporting events.

16) The application of the system according to claim 1 for enhancing officiating of sporting events.

17) The application of the system according to claim 1 for enhancing spectator enjoyment of sporting events

18) The application of the system according to claim 1 for enhancing television viewer enjoyment of sporting events

19) The application of the system according to claim 1 for monitoring of subjects or objects in any area with defined boundaries.

20) The system according to claim 1 for enhancing playing, officiating, statistics generation, spectator enjoyment, or television viewer enjoyment of all sporting events contested at Olympics.

21) The system defined according to claim 1, further comprising a map-like interactive display or overlay to point and click at objects to selectively disable or enable the objects, change frequencies, or send alarm signals.

22) The system according to claim 1 which will alert the control tower or generate automatic alert signals in the plane if an aircraft enters the wrong runway.
